(19) United States
(12) Patent Application Publication
(10) Pub. No.: US 2014/0205524 A1
(43) Pub. Date: Jul. 24, 2014

(54) Gas Component Extraction from Gas Mixture

(71) Applicant: David Sevier, Surry (GB)

(72) Inventor: David Sevier, Surry (GB)

(21) Appl. No.: 13/748,885

(22) Filed: Jan. 24, 2013

(51) Int. Cl. B01D 53/14; B01D 53/78

(52) U.S. Cl. CPC B01D 53/1412; B01D 53/78
USPC 423/220; 423/210; 423/235; 423/238; 423/245.2; 422/162; 62/91

(57) ABSTRACT

A process for extracting a target gas component from a gas mixture in an apparatus having a pair of capture and release sections is provided. The pair of capture and release sections includes a sorbent capture section and a sorbent release section, each of the sorbent capture section and sorbent release section having a high surface area medium and a sorbent contained therein. A gas mixture is directed through a flow path, the flow path directing the gas mixture through the sorbent release section followed by the sorbent capture section, wherein the sorbent within the pair of capture and release sections extracts the target gas component and reduces the target gas component in the gas mixture. The sorbent is directed through a recirculation path, the recirculation path directing sorbent from said collection tank of the sorbent capture section to the entry point of the sorbent release section and directing sorbent from the collection tank of the sorbent release section to the entry point of the sorbent capture section, thereby recycling the sorbent.

### CROSS-REFERENCE TO RELATED APPLICATIONS

This application is a continuation of International Application No. PCT/GB2011/051398, filed Jul. 22, 2011, which claims priority to GB20100012439, filed Jul. 24, 2010.

### TECHNICAL FIELD

The present invention generally relates to target gas component extraction, and, more particularly, to a process for extracting a target gas component from a gas mixture.

### BRIEF DESCRIPTION OF THE DRAWINGS

FIG. 1 is a schematic diagram of an apparatus for extracting a target gas component from a gas mixture, the apparatus formed according to an embodiment of the present invention.

### BRIEF SUMMARY

According to one embodiment, there is provided a process for extracting a target gas component from a gas mixture in an apparatus having a pair of capture and release sections in fluid communication with one another, the pair of capture and release sections including a sorbent capture section and a sorbent release section, each of the sorbent capture section and sorbent release section having a high surface area medium and a sorbent contained therein and including a fluid entry point at a first end and a collection tank at a second end, the process comprising the steps of: directing a gas mixture through a flow path, the flow path directing the gas mixture through the sorbent release section followed by the sorbent capture section, wherein the sorbent within the pair of capture and release sections extracts the target gas component and reduces the target gas component in the gas mixture; and directing sorbent through a recirculation path, the recirculation path directing sorbent from said collection tank of the sorbent capture section to the entry point of the sorbent release section and directing sorbent from the collection tank of the sorbent release section to the entry point of the sorbent capture section, thereby recycling the sorbent, the pair of capture and release sections including a concentration gradient of at least one of the target gas and the sorbent. The sorbent may be at least one of gypsum, ammonia and water.

### DETAILED DESCRIPTION

The extraction of gases, such as carbon dioxide or nitrogen oxides, from air in substantial quantity requires the processing of large volumes of air. Creating a continuous movement of large volumes of air typically requires the input of significant energy by the use of fans. Wind can move large volumes of air, but is rarely continuous and hence will not provide optimal use of gas capture equipment. A continuous flow of air is required for this. Inducing air flows by the evaporation of water using the chimney effect is described in patent application WO2010/032049. In this process, water in its conventional form is sprayed at the top of a chimney such that water evaporates. This cools the air and due to the stack effect and the entrainment of air by the falling water, air is moved down the column. Large flows of slow moving air may be induced in this manner.

When water evaporates, the process is generally governed by temperature, surface area and the humidity of the air. In a flowing air stream, humidity defines the amount of water that can be further evaporated. Increased temperature increases the rate of evaporation and the amount of humidity that can be added to the air. Raising the temperature of large flows of air requires significant energy input which not feasible in a low energy process. However, surface area is a parameter over which useful control can be applied. In order to minimize energy use, droplet size needs to be as small as possible so as to create the maximum surface area to volume ratio. In this way less energy is expended pumping water to create the greatest surface area. However, creating fine droplets has practical limits and in most instances requires increased energy use as finer droplets are created. Nozzle clogging and coalescence also are significant problems. As a result, spraying water for evaporation means that most of the water pumped will not evaporate unless the height of the chimney is very high. Very high chimneys are expensive to build and are generally not practical.

Bubbles offer a useful way of reducing the energy expended pumping water to create large surface areas for evaporation. Bubbles are self-assembling structures that naturally self-limit the thickness of the bubble walls. Equally bubbles present two surfaces to the air which doubles the useful surface area. The energy required to form bubbles is very small. As is known in the art, bubbles form easily if sufficient foaming agent is present and have very large surface area to volume ratios. The ratio of water volume to surface area is unaffected by bubble size. Bubble thickness can vary but is limited to a maximum thickness. Bubbles typically start out with thicker walls which steadily reduce as the water evaporates from the bubbles' surfaces until the wall thickness reduces to the point of popping. When the bubble breaks, fine particles of water are formed which further aids evaporation.

While bubble size has no effect on the ratio of water volume to surface area, bubble size does affect the amount of bubbles that can be packed into a given space: the smaller the bubble, the greater the surface area to water volume ratio per cubic metre of air. For this reason, decreasing bubble size is generally useful. Ideally, the bubbles need to be sufficiently small such that they do not excessively bump into each other and stick together which reduces the surface area but at the same time not so small that the air inside of the bubble becomes so reduced that little evaporation occurs and the double surface is wasted. Equally, the bubbles need to interact with as much of the air column as possible to achieve saturated humidity. This can be aided by spreading out the formation of the bubbles across the top of the column so that the falling bubbles can mix with all parts of the incoming air.

An example of a typical application would be to have a chimney where bubbles of modest size are created evenly across the column cross-section towards the top of a column such that passing wind does not draw out the created bubbles. The bubbles fall and water evaporates from the large surface areas that have been created. The air cools from evaporation. Towards the bottom of the column, most of the bubbles walls have sufficiently thinned so that the bubbles pop. The remaining bubbles and the shattered bubble fragments fall to the bottom of the column. The majority fall into a water sump. Some bubbles and fragments are entrained in the air leaving the air chimney. The air flow passes across a series of sharp points to break the remaining bubbles and then passes through drift eliminators to trap the entrained water particles. The cooled air within the chimney creates a downward falling flow of air due to the stack effect. The high ratio of surface area to volume that bubbles offer means that a very high percentage of the total water that is pumped is directly evaporated. The use of falling bubbles within a chimney creates large volumes of cooled air for low energy input.

In the majority of applications of an induced flow bubble tower or column, the induced draft will be redirected by 90 degrees at the bottom of the column so that broken bubble particles can fall into a sump and air exit on the horizontal. This is ideal for gas capture from the created air flow which can then pass through a series of sprays, fill packs, or bubbles of sorbent to capture or destroy target gas components from the air.

The described induced flow bubble column has applications that extend beyond selective gas capture from gas streams. The falling bubble column offers a means to evaporate water for very low energy. This is useful for applications such as waste water concentration or creating cool air streams. The described process uses sufficiently low energy that it could be used to modify the local or regional water cycle by increasing the humidity of the region's air and reducing the temperature of large volumes of air. The effects will be dependent upon local geography, weather conditions, and the amount of water evaporated.

The process may be for evaporating water, concentrating materials dissolved within the water, and/or supplying air that is saturated with respect to humidity.

As outlined in patent application WO2010/032049, it has been found that the following reaction sequence is particularly useful for capturing carbon dioxide from the air:

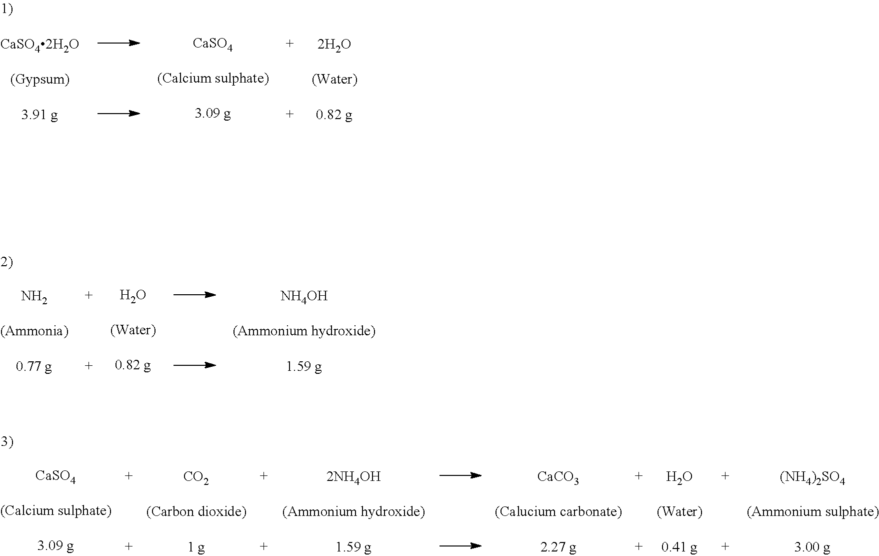

It has been found through experimentation that reaction 3 can be optimized to capture higher percentages of a given target gas component if the level of suspended gypsum and ammonia is increased. Ammonia and ammonium hydroxide are alkali and the greater the concentration of ammonia, the greater the pH. Overall, the greater the level of ammonia/ammonium hydroxide, the greater the rate of carbon capture. However, higher ammonia concentrations mean greater vapour pressures of ammonia. Thus, ammonia gas increasingly strips out of solution as the pH of the working sorbent rises. This is undesirable.

From the discussion that is to follow, it will become apparent how the above-mentioned deficiencies associated with known constructions and techniques are addressed by the present invention, while providing numerous additional advantages not hitherto contemplated or possible with said known constructions.

In at least some embodiments, the spillage of sorbent materials, such as ammonia vapour, from the process is prevented. The concentration gradient also allows a user to manage mediums such as water vapour. In addition the ratio of created calcium carbonate, for instance, to the gypsum reactant may be improved. Further, the concentration of the ammonium sulphate solution may be enabled.

The process may include a step of forming bubbles in a vertical column while the gas mixture flows through the column. The flow of the gas mixture may be redirected by about 90° at the end of the column.

In some embodiments, an induced flow chimney may be employed to create the air/gas mixture flow and then to have the carbon/gas component capture part of the process run along the ground. The carbon capture part of the process may be up to 26 metres long, for example. In this way, the column may not necessarily be vertical. In some embodiments the linked capture and release pairs manage the ammonia vapour in a configuration where the column is not completely vertical. However, the stack effect operates most efficiently when the induced air flow column is vertical. The carbon capture may be achieved with the joined capture and release pairs in the horizontal configuration.

The flow of the gas mixture may be substantially perpendicular to the flow of the sorbent on contact therewith. An arrangement of linked capture and release sections may be used. However alternate arrangements may also be used. In the arrangement of capture and release pairs, a tube with walls of fill pack set into it may be employed. Optionally, it is possible to have a series of mini columns where air flows up one column and then may be redirected and then enter another column and rise up again.

In addition, the process may include the step of using a foaming agent to induce bubble formation. The target gas component may include at least one of carbon dioxide, nitrogen oxide, ammonia, methane and water vapour. The gas mixture may include air. The air may be enriched with gases created from combustion or another industrial process. The high surface area medium may be in the form of a spray, a fill pack, a solution or a collection of individual bubbles.

Bubbles require low energy to form and have a large surface area in relation to their liquid volume so the amount of fluid pumped may be advantageously used. Bubbles create vast surface areas for very low energy at a low cost. Equally, bubbles create less back pressure and provide significantly less wind resistance than other forms of increasing surface area.

As an alternative to complete removal of ammonia vapour from the gas mixture prior to exit using capture and release pairs, a sulphuric acid scrubbing step for removing low level ammonia vapour may be incorporated into the process. The addition of a final acid scrubber further reduces the energy and capital cost of controlling the ammonia vapour. For example, as shown in reaction (4) below, sulphuric acid may be used as a final acid scrubber to produce ammonium sulphate, which is also one of the products produced by reaction (3).

The extraction of the target gas component may be for the capture and/or destruction thereof. It may be that using the process described above, carbon dioxide is extracted from air according to the following reactions:

CaSO₄.2H₂O→CaSO₄+2H2O 1)

NH₃+H₂O→NH₄OH 2)

CaSO₄+CO₂+2NH4OH→CaCO₃+H₂O+(NH₄)₂SO₄ 3)

H₂SO₄+2NH₃→(NH₄)₂SO₄ (4)

According to another aspect of the present invention, there is encompassed a process of cooling air using water, comprising the steps of:
generating water bubbles;
providing a column open at its top end;
feeding the water bubbles into the column at its top end;
allowing the bubbles to sink and evaporate, thereby generating cool air and inducing a downward air flow.

In at least some embodiments, by using bubbles, virtually all the water pumped is evaporated if the chimney is made high enough and, perhaps, if it is not raining (this makes the air have 100% humidity). This make the process a substantially lower energy cost means of inducing very large air flows. Bubbles offer the advantage of being able to create large surface areas and not creating significant air resistance and not requiring high energy input. The use of bubbles in this manner may produce a process which requires up to about 1000 times less energy to generate cool air and induce air flow than conventional processes. The water may be fresh water, salt water, or sourced from waste water that is contaminated with impurities.

According to a further aspect of the present invention, there is an apparatus for extracting a target gas component from a gas mixture. The apparatus includes a pair of capture and release sections in fluid communication with one another, the pair of capture and release sections including a sorbent capture section and a sorbent release section, each of the sorbent capture section and a sorbent release section having a high surface area medium and a sorbent contained therein and including a fluid entry point at a first end and a collection tank at a second end, the pair of capture and release sections including a concentration gradient of at least one of the target gas and the sorbent. The apparatus also includes a recirculation path for directing sorbent from the collection tank of the sorbent capture section to the entry point of the sorbent release section and for directing sorbent from the collection tank of the sorbent release section to the entry point of the sorbent capture section. In addition, the apparatus includes a gas mixture flow path for directing the gas mixture through the pair of capture and release sections, the gas mixture flow path directing the gas mixture through the sorbent release section followed by the sorbent capture section, wherein the sorbent within the pair of capture and release sections extracts the target gas component and reduces the amount of target gas component in the gas mixture.

The apparatus may be for capture and/or destruction of a target gas component of a gas mixture. The apparatus may comprise a further target gas component extraction section situated between the at least one pair of capture and release sections. It will be appreciated that in a series of pairs of capture and release sections, all the pairs may capture a target gas component, such as CO₂ or other gases. However, efficiency is greatest at the center of the series of pairs since the conditions are most optimal at the center. It may be possible to configure the cascade as only having capture and release pairs but including a section located between the capture and release sections. Thus, there may be a section where the ammonia concentration is higher and yields higher capture rates.

The process may be seen as a self-refining process. The concentration of the products may, therefore, be managed in an efficient way (for instance of the chalk). The bubbles offer a manner of managing the concentrations of the media to a greater extent than known methods.

The target gas component extraction section and/or the at least one pair of capture and release sections may be containers and/or columns. The apparatus may comprise means for feeding the gas mixture to the at least one pair of capture and release sections. The said feeding means may be configured to feed the gas mixture in direction substantially perpendicular to the flow of sorbent. The sections may comprise a sump for receiving sorbent. The sump of one of the pair of capture and release sections may be in fluid communication with the top of the other of the pair of capture and release sections.

The apparatus may be adapted for a sorbent which comprises at least one of gypsum, ammonia and water. The apparatus may comprise means for forming bubbles from the gas mixture, and a column for passing the bubbles there through. The end of the column may be operable to redirect the flow of the gas mixture by about 90°. The apparatus may be adapted for a target gas component which includes at least one of carbon dioxide, nitrogen oxide, ammonia, methane and water vapour. The gas mixture may include air, which may be enriched with gases created from combustion or another industrial process. In addition, the apparatus may include a high surface area medium which is in the form of a spray, a fill pack, a solution or a collection of individual bubbles.

If fill packs are used to create large surface areas, it has been found to be beneficial to use rotating arm water spreaders to distribute the fluid across the top of the fill packs. Rotating arm spreaders have been widely used to spread water within cooling towers and in the waste water industries for many years. They represent a low energy method of spreading water. This is useful but rotating spreaders have another particularly useful advantage for carbon capture. Rotating spreaders do not continuously deliver fluid to all parts of the fill pack at the same time. The carbon capture or gas absorbing process is limited by the rate of gas molecules diffusing into the liquid surface. This happens relatively slowly. Fluids and materials delivered to a fill pack surface do not immediately fall off the fill pack and continue to create thin films for some time after they are delivered onto the fill pack surfaces. This means that fluids to create films do not need to be added continuously. A rotating spreader is a uniquely useful device in this application which periodically refreshes fluid across the fill packs while also delivering fluid to the surface of the fill pack for low energy. This means that fewer reactants and fluid have to be delivered across the fill packs to capture a given amount of carbon. The reduced pumping means that less energy is required as compared to continuously pumping fluid across the top of the fill packs which is a significant and useful advantage. The rate of rotation of the spreader directly correlates to the rate of the fluid refreshment rate. Adjustment of this rate means that the energy of pumping can be optimized to deliver minimal energy input.

### DETAILED DESCRIPTION OF THE EMBODIMENTS

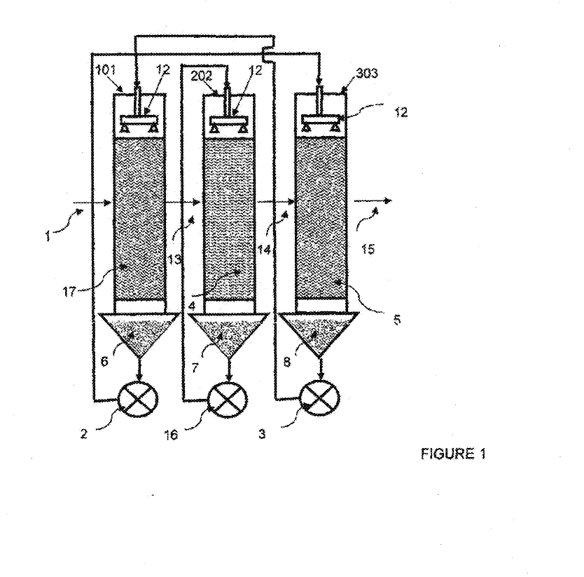

A brief outline of the features and processes of FIG. 1 is as follows. The incoming air or gas mixture is indicated 1. A capture and release pair is shown including a sorbent release section 101 and a sorbent capture section 303. A recirculation pump 2 of sorbent release section 101 feeds solution to the top of sorbent capture section 303. A target gas component capture section 202 includes recirculation pump 16. A recirculation pump 3 of sorbent capture section 303 feeds solution to the top of sorbent release section 101. Fluid trickles downwards as a thin film over a high surface area medium, such as fill pack 17 of sorbent release section 101. Air passes through at a 90° angle to the falling fluid. Fill packs 4 and 5 that have the same configuration but are in target gas capture section and sorbent capture section, 202 and 303, respectively. Sorbent release section 101 includes a conical tank 6 to collect the falling fluid that falls from fill pack 17. The target gas capture section and sorbent capture section, 202 and 303 comprise sumps 7 and 8, respectively. Fluid distribution system 12 evenly spreads the fluid across the top of fill packs 17, 4 and 5. Indicated at 13, is air or gas that has ammonia gas mixed in from the stripping process that occurred in fill pack 17. Indicated at 14, is air or gas that has further ammonia gas that has evaporated from the high ammonia concentration in target gas component capture section 202. Indicated at 15, is air or gas that has reduced ammonia concentration relative to 14 due to the absorption of ammonia into solution in fill pack 5.

Referring now in more detail to FIG. 1, in this system/apparatus, a gas mixture (air) 1 enters sorbent release section 101 where ammonia vapour is released from the falling fluid solution. Air 13 then passes to target gas component capture section 202 where carbon capture occurs. The high concentration of ammonia from the sorbent system means that ammonia vapour is unavoidably added to the air 13. Air 14 then passes to sorbent capture section 303. The pumped liquid falling through sorbent capture section 303 is supplied from the sump 6 of sorbent release section 101. This solution is low in ammonia which was released into the air 1 in the sorbent release section 101. The low ammonia solution is sprayed in sorbent capture section 303 and absorbs ammonia from the air 14 that passes through sorbent capture section 303. The air 15 that leaves sorbent capture section 303 has reduced ammonia vapour. The liquid that is within the sump 8 of sorbent capture section 303 has increased ammonia concentration and is then passed to the top of sorbent release section 101 where it gives up its excessive ammonia as it falls through sorbent release section 101. In this way, a balance of ammonia absorption in sorbent capture section 303 and release in sorbent release section 101 is maintained.

Additional pairs of ammonia capture and release units are used to contain ammonia vapour in a commercial system. The number of absorption pairs required is dependent upon the operating pH of the central target gas component capture section, the air temperature and the air velocity in ratio to the absorption surface area. Temperature has a particular bearing on this. In colder conditions, there is less ammonia vapour and in warmer conditions, more. Any commercial carbon capture system will need to plan for the warmest part of the year. This can be done through insuring that enough pairs of capture and release units are present for the warmest possible day or plan to reduce ammonia capture requirements on excessively hot days by reducing operating ammonia concentration. Due to continuous consumption of ammonia by the process (reaction 3), adjusting the ammonia concentration is possible.

The cost of complete removal of ammonia vapour from the gas mixture prior to exit using capture and release pairs can be reduced by incorporating a sulphuric acid scrubbing step which removes low level ammonia vapour. The addition of a final acid scrubber reduces the energy and capital cost of controlling the ammonia vapour. If the carbon capture reaction outlined in reaction three is used, using sulphuric acid as the acid in the final acid scrubber is an advantage because ammonium sulphate is produced which is one of the products produced by reaction three.

A single pair of capture and release units have been found to be able to control excessive ammonia vapour and produce no odour if the pH of the sorbent solution for capture was 10.2 (air temperature was a 28° C. for this test). The process of the ammonia capture is seen by the pH differential of the different capture units. The steady state recorded pHs were:

First unit (the ammonia release unit): 9.5
Second unit (the carbon capture unit): 10.22
Third unit (the ammonia capture unit): 9.65

In each unit, fluid is sprayed across the top of a fill pack to create a falling thin film of solution that has a large surface area to volume ratio. This fluid interacts with the air 1, 13, 14 and 15 that is moving horizontally through the fill pack 17, 4 and 5 holes. There are alternative methods to create large surface to area volume ratios for good gas interaction such as fine sprays of water or bubbles of solution. The described process is not exclusive to any one method of creating large surface area to volume of sorbents/solvents. It is possible to use a mixture of fill packs for the inner units that contain ammonium sulphate and precipitated chalk and, bubbles created by the addition of foaming agents to fully absorb and release the ammonia vapour in the outer units. This configuration avoids contaminating the created ammonium sulphate solution with foaming agents and is less expensive to build as fewer fill packs are required. Ammonium sulphate and precipitated calcium carbonate are removed in the outer pair 101 and 303 of sorbent capture and release sections before the bubbles and foaming agents are used. To prevent drift of particles of water and foaming agent, drift eliminators are fitted between the units that use bubbles and the units that are based upon fill packs. In situations where mixing ammonium sulphate with foaming agent is not seen as an issue, bubbles can be used throughout the process and fill packs avoided.

The sorbent solution is contained within target gas component capture or extraction section 202. A useful sorbent solution that uses reaction 3 to capture CO₂ from the gas stream is a mixture of suspended ground powdered gypsum, ammonia and water. As the mixture reacts with carbon dioxide from the air, precipitated calcium carbonate and ammonium sulphate (which is highly soluble) are produced; this creates a dilute solution of ammonium sulphate and a mixture of gypsum and chalk. The mixture is continuously recycled to increase the concentration of ammonium sulphate and raise the concentration of chalk. The sorbent is transferred from the target gas component capture section 202 in the centre of the process to the pair of sorbent (ammonia) capture and release sections 101 and 303 directly next to it. Within the ammonia capture and release units, carbon capture occurs that increases the ratio of chalk to gypsum. Sorbent from the first pair of ammonia capture and release units is then moved progressively outward through the pairs of ammonia capture and release units. In the outer pair of units, high purity chalk and high strength ammonium sulphate solution are removed. This arrangement generally avoids the need to separate the created chalk from the input gypsum by a differential settling cascade. The gypsum concentration is progressively reduced by reaction three as the gypsum/chalk mixture moves through the process until gypsum contamination levels become low at the point where the purified chalk is removed.

The ammonia concentration increases as you move towards target gas component capture section 202 where it is at a maximum. The rate of carbon capture, which is tied to ammonia concentration, decreases as you move outward from target gas component capture section 202. The concentration of ammonium sulphate increases as you move outward towards the outer pair of capture and release sections. Equally the purity of the chalk mixture improves as you move outward from the centre. The concentration gradients also assist in water vapour control. High concentration salt solutions tend to reach equilibrium with the moisture within the atmosphere such that at sufficient concentration, they absorb moisture from the air. In this way, the full size process will evaporate little to no fresh water because the outer pair of capture and release sections will end up creating an ammonium sulphate solution that has a water vapour pressure that is in equilibrium with the air. In this way, little fresh water is required to be added to the process except to make-up for water removed when ammonium sulphate solution is extracted and to balance the small amount of drift losses. A small amount of water evaporation does occur if ammonium hydroxide solution is supplied to target gas component capture section 202.

If the described induced flow bubble column is used, saturated humidity air will then pass through the progression of pairs of capture and release sections. Essentially, no water vapour will be lost from the series of capture and release sections as the air entering the sections will be saturated with water vapour. Consequently, the content of water will remain constant throughout the series of capture and release sections and ammonium sulphate will concentrate to a lower concentration than if water evaporation could take place. Further, concentration of the ammonium sulphate to create saturated solutions will require water evaporation. This can be done outside of the capture process.

An induced flow bubble column may be included to supply air flow to a series of capture units that maximize carbon dioxide capture and fully contains the ammonia vapour used in the process. Concentrated ammonium sulphate and high purity precipitated calcium carbonate is removed from the outer pair of capture and release sections. Water is only evaporated from the induced flow bubble column which can use fresh, waste, brackish or salt water as a supply source.

The described arrangement can be used with other chemical reactions. A number of variations will be apparent to skilled artisan.

According to an aspect of the present invention, there is provided a process where water is evaporated from bubbles within a column that is open at the top and the bottom such that the air is cooled due to evaporation and creates a downward air flow due to the stack effect and the water used is fresh, salt or sourced from waste water that is contaminated with impurities.

According to another aspect of the present invention, there is provided a process of water evaporation from bubbles in moving air to create a low energy process to evaporate water and/or to concentrate materials dissolved within the water and/or to supply air that is saturated with respect to humidity.

According to a further aspect of the present invention, there is provided a process of using a series of paired capture and release sections where the fluid that has fallen to the bottom of one section is delivered to the top of the opposite section to absorb or release ammonia or water vapour and the paired sections are joined such that fluid and solids can progressively move outwards from the centre of the conjoined sectional pairs.

In embodiments, the process above may be such that the reactants are feed into the centre of the progression of paired sections and purified reaction products are removed from the outer joined pair. The process above may be used to capture carbon dioxide, nitrogen oxides and methane gases. In addition, the process above may operate on air that is enriched with gases created from combustion or another industrial process.

According to another aspect of the present invention, there is provided the use of rotating arm spreaders to deliver fluids and solids across a fill pack section that is being used to capture carbon dioxide and/or manage ammonia and water vapour.

According to yet a further aspect of the present invention there is provided the dissolved/suspending of reactants within the fluid used to make-up bubbles within a gas stream to capture or release a gas within said gas stream.

In embodiments, the process above may be such that it is used to:
Capture carbon dioxide
Capture and release ammonia
Capture and release water vapour.

The foregoing descriptions of specific embodiments of the present invention have been presented for purposes of illustration and description. They are not intended to be exhaustive or to limit the invention to the precise forms disclosed, and various modifications and variations are possible in light of the above teachings. The embodiments were chosen and described in order to explain the principles of the invention and its practical application, to thereby enable others skilled in the art to utilize the invention and various embodiments with various modifications as are suited to the particular use contemplated.

I claim:

1. A process for extracting a target gas component from a gas mixture in an apparatus having at least one pair of capture and release sections in fluid communication with one another, said at least one pair of capture and release sections including a sorbent capture section and a sorbent release section, each of said sorbent capture section and sorbent release section having a high surface area medium and a sorbent contained therein and including a fluid entry point at a first end and a collection tank at a second end, said process comprising the steps of:
directing a gas mixture through a flow path, said flow path directing the gas mixture through the sorbent release section followed by the sorbent capture section, wherein the sorbent within said at least one pair of capture and release sections extracts the target gas component and reduces an amount of target gas component in the gas mixture; and
directing sorbent through a recirculation path, said recirculation path directing sorbent from said collection tank of the sorbent capture section to the entry point of the sorbent release section and directing sorbent from the collection tank of the sorbent release section to the entry point of the sorbent capture section, thereby recycling the sorbent, and said at least one pair of capture and release sections including a concentration gradient of at least one of the target gas and the sorbent.

2. The process of claim 1, wherein the sorbent comprises at least one of gypsum, ammonia and water.

3. The process of claim 1, including the step of inducing flow of the gas mixture by passing the gas mixture vertically through an induced flow bubble column.

4. The process of claim 3, wherein the flow of the gas mixture is redirected by about 90° at the end of the induced flow bubble column.

5. The process of claim 1, wherein the flow of the gas mixture is substantially perpendicular to the flow of the sorbent on contact therewith.

6. The process of claim 3, including the step of using a foaming agent to induce bubble formation.

7. The process of claim 1, wherein the target gas component includes at least one of carbon dioxide, nitrogen oxide, ammonia, methane and water vapour.

8. The process of claim 1, wherein the gas mixture includes air.

9. The process of claim 8, wherein the air is enriched with gases created from combustion or another industrial process.

10. The process of claim 1, wherein the high surface area medium is a spray, a fill pack, a solution or a collection of individual bubbles.

11. The process of claim 1, further including the step of using sulphuric acid to scrub ammonia vapour.

12. The process of claim 1, wherein the target gas component is captured or destroyed.

13. The process of claim 1, wherein the target gas component is carbon dioxide, with said carbon dioxide being extracted from the gas mixture according to the following reactions:
CaSO4.2H2O->CaS04+2H20 1)
NH3+H20->NH4OH 2)
CaS04+C02+2NH4OH->CaC03+H20+(NH4)2S04 3)

14. The process of claim 1 wherein the step of directing a gas mixture through a flow path further includes directing the gas mixture through a target gas component extraction section having a high surface area medium and a sorbent contained therein and further including a fluid entry point at a first end and a collection tank at a second end, wherein the sorbent within the target gas component extraction section extracts and further reduces the target gas component from the gas mixture.

15. The process of claim 1 further comprising a step of directing sorbent through a second recirculation path, said second recirculation path directing sorbent from a collection tank of a second sorbent capture section to an entry point of a second sorbent release section and directing sorbent from the collection tank of the second sorbent release section to the entry point of the second sorbent capture section, thereby recycling the sorbent.

16. The process of claim 1 where the at least one pair of capture and release sections is used to contain sorbent vapour.

17. A process of cooling air using water, comprising the steps of:
generating water bubbles;
providing a column open at its top end;
feeding the water bubbles into the column at its top end;
allowing the bubbles to sink and evaporate, thereby generating cool air and inducing a downward air flow.

18. The process of claim 17, wherein the water is fresh water, salt water, or sourced from waste water that is contaminated with impurities.

19. The process of claim 17 further comprising evaporating water, concentrating materials dissolved within the water, or supplying air that is saturated with respect to humidity.

20. An apparatus for extracting a target gas component from a gas mixture, comprising
at least one pair of capture and release sections in fluid communication with one another, said at least one pair of capture and release sections including a sorbent capture section and a sorbent release section, each of said sorbent capture section and a sorbent release section having a high surface area medium and a sorbent contained therein and including a fluid entry point at a first end and a collection tank at a second end, said at least one pair of capture and release sections including a concentration gradient of at least one of the target gas and the sorbent;
a recirculation path for directing sorbent from said collection tank of the sorbent capture section to the entry point of the sorbent release section and for directing sorbent from the collection tank of the sorbent release section to the entry point of the sorbent capture section; and
a gas mixture flow path for directing the gas mixture through said at least one pair of capture and release sections, said gas mixture flow path directing the gas mixture through the sorbent release section followed by the sorbent capture section, wherein the sorbent within said at least one pair of capture and release sections extracts the target gas component and reduces an amount of target gas component in the gas mixture.

21. The apparatus of claim 20, wherein the apparatus is for capture and/or destruction of a target gas component of a gas mixture.

22. The apparatus of claim 20, further comprising a target gas component extraction section having a high surface area medium and a sorbent therein, wherein the target gas component extraction section is situated between said at least one pair of capture and release sections.

23. The apparatus of claim 20, wherein the gas mixture flow path is configured to feed the gas mixture in a direction substantially perpendicular to a flow of sorbent through the at least one pair of capture and release sections.

24. The apparatus of claim 22, further including additional pairs of capture and release sections, each of said additional pairs of capture and release sections including a sorbent capture section and a sorbent release section, each of said sorbent capture section and a sorbent release section having a high surface area medium and a sorbent contained therein and including a fluid entry point at a first end and a collection tank at a second end, said additional pair of capture and release sections including a concentration gradient of the target gas and/or the sorbent; each additional pair of capture and release sections including a recirculation path for directing sorbent from said collection tank of the sorbent capture section to the entry point of the sorbent release section and for directing sorbent from the collection tank of the sorbent release section to the entry point of the sorbent capture section.

25. The apparatus of claim 20, wherein the sorbent includes at least one of gypsum, ammonia and water.

26. The apparatus of claim 20, further comprising an induced flow bubble column for vertically inducing the flow of the gas mixture towards the at least one pair of capture and release sections, wherein the end of the induced flow bubble column is operable to redirect the flow of the gas mixture by about 90°.

27. The apparatus of claim 20, wherein the target gas component includes at least one of carbon dioxide, nitrogen oxide, ammonia, methane and water vapour.

28. The apparatus of claim 27, wherein the gas mixture includes air enriched with gases created from combustion or another industrial process.

29. The apparatus of claim 20, wherein the high surface area medium is a spray, a fill pack, a solution or a collection of individual bubbles.

30. The apparatus of claim 29, comprising rotating arm spreaders to deliver fluids and solids across a fill pack.
